(19) United States
(12) Patent Application Publication
(10) Pub. No.: US 2009/0071522 A1
(43) Pub. Date: Mar. 19, 2009

(54) Tent structure having waterproof bottom corners and method for manufacturing the same

(76) Inventor: Gi Weon Seo, Paju City (KR)

Correspondence Address: GWIPS;Peter T. Kwon, Gwacheon P.O. Box 72, 119 Byeolyang Ro, Gwacheon City, Gyeonggi-Do, 427-600, KR

(21) Appl. No.: 11/900,830

(22) Filed: Sep. 13, 2007

(51) Int. Cl. E04H 15/56; B29C 65/02

(52) U.S. Cl. 135/116; 156/251

(57) ABSTRACT

A waterproof bottom corner of a tent structure and a method for manufacturing the same are developed. Extra clad cloths are welded on the inside and outside of the tent bottom cloth. The overlapped bottom corner tent structure is heated and welded. Then, an eyelet is mounted on the end portion, so that the waterproof bottom corner of the tent effectively protects against moisture. Therefore, it is easy and convenient to use the tent outdoors.

### BACKGROUND OF THE INVENTION

1. Field of the Invention

The present invention relates to the waterproof bottom corners of a tent structure and a method for manufacturing the same. More particularly, extra layers of cloth on the inside and outside of the waterproof bottom corners of the tent structure are welded to the bottom cloth and an eyelet is mounted at the end portion. Thus, the waterproof bottom corner of the tent structure effectively prevents the penetration of moisture, so that it is convenient and easy to use the tent outdoors.

2. Related Prior Art

A tent is installed and used in the open field, seashore or mountain camp site for various outdoor activities. An ordinary tent is composed of a rhombic tent body cloth functioning as an awning and wind-breaker and an extra bottom cloth that is clad to the bottom of the tent body cloth. Especially the bottom cloth should have excellent waterproofing qualities.

For the bottom cloth, a flat sheet-shaped cloth is folded into a flat quadrangular, pentagonal or hexagonal form, which is then clad to the tent body cloth. Each corner portion of the bottom cloth includes a seam of stitching and a waterproof clad cloth for sealing the seam.

Namely, as shown in FIG. 1, after the overlapping portion of the bottom cloth 100, which is cut to form a corner portion, is sewn, another clad cloth 101 is put over the inside of the sewn corner portion, which is then welded by heat to complete the corner portion of the bottom cloth. The clad cloth plays a role of improving the watertightness of the corner portion that may otherwise leak due to the presence of the seam.

In addition, on the outside of the corner portion to which the clad cloth 101 is clad in this manner, one part of the overlapping portion extended by the seam is punched, and an eyelet 102 is mounted in this overlapping portion. When the tent is deployed, a pole or stake is inserted into the eyelet 102, and then driven into the ground to be fixed.

However, the corner portion of the tent bottom cloth as described above has a problem in that the watertight and waterproof qualities are lowered by perforation during sewing, because both sides of the cut bottom cloth are joined by stitching. Another problem is that the joined portion cracks apart when the stitching is not good or damaged by external friction.

Moreover, since the clad cloth is welded to the inside of the overlapped bottom cloth, the welding process is very difficult and troublesome, so producibility is lowered greatly. And the eyelet is fixed to the bottom cloth itself, so if excessive tension or external force is applied, the bottom cloth is tom, making the use of the tent difficult, causing a problem with reliability of the product.

### SUMMARY OF THE INVENTION

To solve the above mentioned problems, it is an object of the present invention to provide a waterproof structure of a tent bottom corner and the method of forming the same by which both end portions of a cut bottom cloth are overlapped and heat-welded together, and a clad cloth is positioned and heat-welded over the outer surface of the heat-welded portion. An additional clad cloth is heat-welded under the bottom cloth with a shape corresponding to the first clad cloth, and an eyelet is fixed to the end portion of the clad cloth extending outward past the bottom cloth so as to have water tightness increased.

To achieve the above objects, there is provided a method of forming a waterproof structure of a tent bottom corner, comprising: a step in which the tent bottom cloth is cut, the cut ends are overlapped then heated and pressed together at high temperature to form a heat-welded joint; a step in which a lateral clad cloth longer than the length of said heat-welded joint is heated and pressed onto the outer surface of said heat-welded portion; and a step in which a lower clad cloth of a size the same as said lateral clad cloth is heated and pressed at high temperature onto the tent bottom cloth in a position corresponding to the position where said lateral clad cloth is welded, wherein one end of each of the lateral clad cloth and lower clad cloth extending from the end portion of the tent bottom cloth are heat-welded to each other by the welding process of said lower cloth; and a step in which an eyelet is mounted into the overlapping portion where said lateral clad cloth and lower clad cloth are welded together.

In accordance with an aspect of the present invention, there is provided a waterproof structure of a tent bottom corner, comprising: a heat-welded portion in which cut-out portions on both sides of the tent bottom cloth are overlapped and heat-welded to form an upward lateral portion, a lateral clad cloth which has a size longer than the length of said heat-welded portion and which is heat-welded to the outer surface of said heat-welded portion, and a lower clad cloth which is heat-welded under the heat-welded tent bottom cloth in a position corresponding to said lateral clad cloth, wherein said lateral clad cloth and said lower clad cloth have the same length and extend to a predetermined length from the end portion of the tent bottom cloth, and an eyelet is mounted into the heat-welded portion of said extending lateral clad cloth and lower clad cloth.

According to the present invention, the watertight and waterproof qualities are improved by heat-welding, and the attachment positions of the clad cloths are improved so as to improve producibility. Also, an eyelet is fixed to the end portion of the clad cloth, which has physical properties stronger than the bottom cloth, so its service life can be greatly prolonged, and even if it is damaged by excessive tensile force or external force, only the clad cloth portion needs to be repaired for reuse, so it is very economical.

### BRIEF DESCRIPTION OF THE DRAWINGS

FIG. 1 is a perspective view showing a partial enlargement of the corner portion of an ordinary tent bottom cloth.

FIG. 2 is a perspective view showing a partial enlargement of the corner portion of the tent bottom cloth according to the present invention.

FIGS. 3a to 3d are process charts showing the process of manufacturing the tent bottom cloth according to the present invention.

FIG. 3a is a process chart showing the process of welding the bottom cloth.

FIG. 3b is a process chart showing the process of welding the lateral finish sheet.

FIG. 3c is a process chart showing the process of welding the bottom finish sheet.

FIG. 3d is a process chart showing the process of fixing the eyelet in the corner portion with the finish sheet welded.

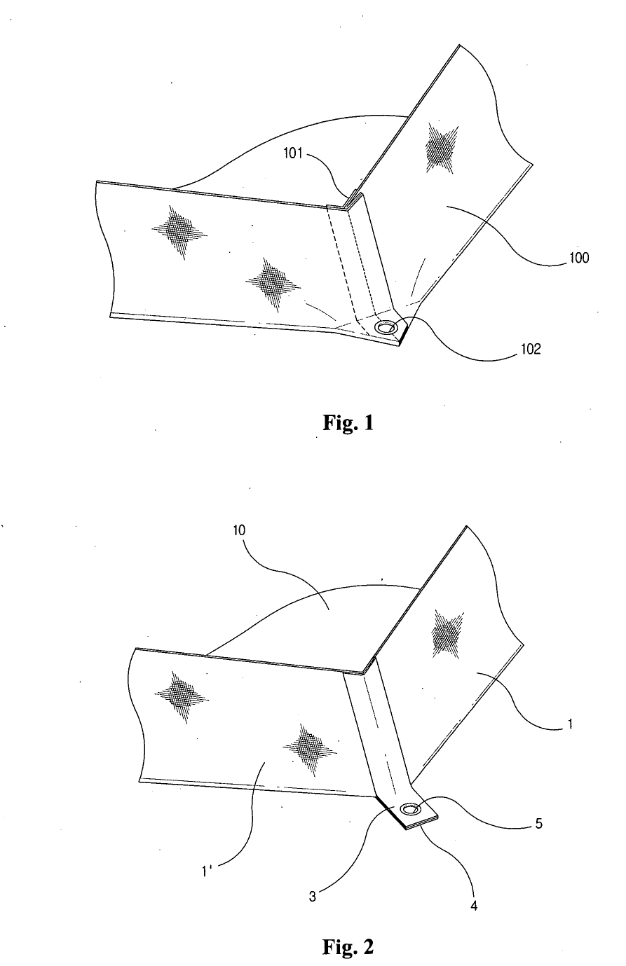

### DETAILED DESCRIPTION OF THE PREFERRED EMBODIMENTS

Below will be described a preferred embodiment of the present invention with reference to the accompanying drawings.

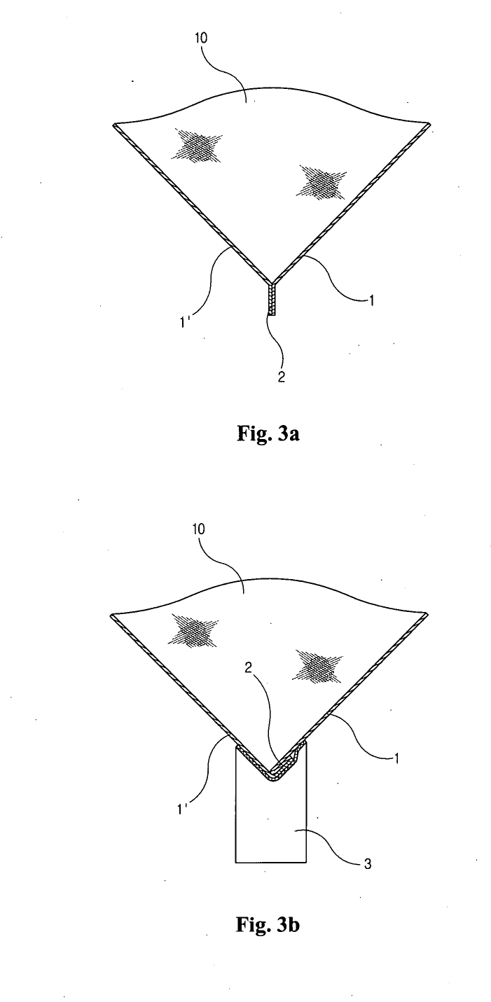

FIG. 2 is a perspective view showing a partial enlargement of the tent bottom cloth according to the present invention.

First, the method of forming the waterproof structure of the tent bottom corner according to the present invention will be described.

Both ends of the tent bottom cloth are cut and overlapped, then heated and pressed together to form a heat-welded portion. Then, an extra lateral clad cloth longer than the heat-welded portion is heated and pressed at high temperature onto the outer surface of the welded portion.

Next, a lower clad cloth of a size the same as the lateral clad cloth is heated and pressed onto the tent bottom cloth in the position corresponding to the position where the lateral clad cloth is welded.

At this time, the lateral clad cloth extending from the end portion of the tent bottom cloth and one end of the lower clad cloth are heat-welded to each other through the welding process of the lower clad cloth.

By inserting and fixing an eyelet in one part of the overlapping portion where the lateral clad cloth and lower clad cloth are heat-welded, the waterproof structure of a tent bottom corner is completed.

The waterproof structure of a tent bottom corner formed by this method is made as follows:

Namely, it comprises a heat-welded portion 2 which is heated and pressed at high temperature after overlapping the ends of both cut portions 1 and 1′ of the tent bottom cloth 10 for forming the upward lateral portion, a lateral clad cloth 3 which has a size longer than the length of the heat-welded portion 2 and is heat-welded onto the outer surface of the heat-welded portion 2, and another lower clad cloth 4 which is heat-welded in a position corresponding to the lateral clad cloth 3 under the tent bottom cloth 10 where the lateral clad cloth 3 is heat-welded.

At this time, the lateral clad cloth 3 and the lower clad cloth 4 have identical length, and extend from the end portion of the tent bottom cloth 10. The extended lateral clad cloth 3 and the lower clad cloth 4 are heat-welded to each other, and an eyelet 5 is inserted and fixed in one part of the heat-welded portion.

Below will be described in more detail the waterproof structure of a tent bottom corner and its forming method according to the present invention with reference to the accompanying drawings.

As shown in the drawings, in the tent bottom cloth of the present invention, the cut portions 1 and 1′ formed in the flat bottom cloth 10 of a tent are raised and overlapped to form the corner of a tent.

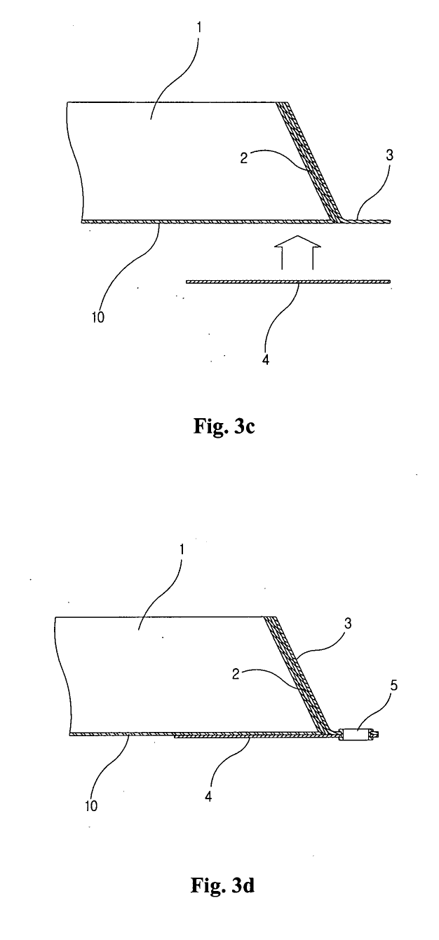

At this time, by heat-welding the cut portions 1 and 1′ with a press roller and a heat roller of a welding means while they are overlapped, a heat-welded portion 2 as shown in FIG. 3a is formed. The completed heat-welded portion 2 has a high degree of watertightness and an excellent claddability, because the mutually overlapped tent bottom cloth 10 is clad while being mutually melted and fused.

In such a condition, an extra lateral clad cloth 3 is put over the outer surface of the heat-welded portion 2 as shown in FIG. 3b, and the lateral clad cloth 3 and heat-welded portion 2 are heated and pressed to clad these to each other.

The lateral clad cloth 3 plays a role of waterproof cloth for filling any gaps that might be generated in the heat-welded portion 2, while playing the role of reinforcing cloth for mounting an eyelet 5.

In addition, as mentioned above, with the lateral clad portion 3 formed, an extra lower clad cloth 4 is put in position and it is heated and pressed to be heat-welded, as shown in FIG. 3c. At this time, the position and length of the lower clad cloth 4 corresponds to that of the lateral clad cloth, and the lateral clad cloth 3 is heat-welded to the lower surface of the tent bottom cloth 10.

In such a cladding process of the lower clad cloth 4, the end portion of the lower clad cloth 4, that is, the part extending from the end portion of the tent bottom cloth 10 is heat-welded to the lateral clad cloth 3, and the end portion of the lateral clad cloth 3 and the lower clad cloth 4 are also heat-welded together by heating and pressing. Accordingly, a stronger and more durable structure extends from the tent bottom cloth 10, as compared to the prior art.

By punching such an extended portion and mounting an eyelet 5 made of metal as shown in FIG. 3d, the corner portion of the tent bottom cloth 10 is completed.

Accordingly, the corner portion of a tent bottom cloth as described above shows excellent watertightness, while it is suited for mass production since convenience of fabrication is improved. Furthermore, an eyelet 5 is fixed to a double layer of clad cloth, so its service life is greatly prolonged due to its excellent durability even when installing the tent using a pole or stake.

As described above, the watertight and waterproof qualities are improved by heat-welding, and the attachment position of the clad cloth is improved so as to improve workability. Also, an eyelet is fixed to the end portion of the clad cloth having physical properties stronger than the bottom cloth, so its service life can be greatly prolonged, and even if it is damaged by excessive tensile force or external force, only the clad cloth portion needs to be repaired for reuse, so it is very economical.

What is claimed is:

1. A method for manufacturing waterproof bottom corners of a tent structure comprising the steps of:
cutting and overlapping both bottom ends of the tent cloth, then heating and pressing with high temperature to form a heat-welded joint,
heating and pressing the outer surface of said heat-welded joint with a lateral clad cloth that is longer than the length of said heat welded pattern,
heating and pressing a lower clad cloth of the same size as said lateral clad cloth at high temperature on the tent bottom cloth in a position corresponding to the position where said lateral clad cloth is welded, wherein one end of each of the lateral clad cloth and the lower clad cloth extending from the end portion of the tent bottom cloth are heat-welded to each other by the welding process of said lower cloth, and
installing an eyelet by inserting and fixing it on the overlapping portion where said lateral clad cloth and lower clad cloth are welded.

2. A waterproof bottom corner of a tent structure comprising:
a heat-welded portion (2) in which cut portions (1, 1′) on both sides of the tent bottom cloth (10) are overlapped and heat-welded to form an upward lateral portion,
a lateral clad cloth (3) which has a size longer than the length of said heat-welded portion (2) and which is heat-welded to the outer surface of said heat-welded portion (2), and
a lower clad cloth (4) in which said lateral cloth (3) is heat-welded under the heat-welded tent bottom cloth (10) in a position corresponding to said lateral clad cloth (3), wherein said lateral clad cloth (3) and said lower clad cloth (4) have the same length and extend to a predetermined length from the end portion of the tent bottom cloth (10), and
an eyelet (5) is inserted and fixed in the heat-welded portion of said extended lateral clad cloth (3) and lower clad cloth (4).
